(19) United States
(12) Patent Application Publication
(10) Pub. No.: US 2010/0095309 A1
(43) Pub. Date: Apr. 15, 2010

(54) NOTIFICATION SYSTEM FOR PUBLIC TRANSPORTATION VEHICLES

(75) Inventors: Robert C. Angell, West Greenwich, RI (US); James Richard Lavoie, Voluntown, CT (US)

Correspondence Address: RYAN, MASON & LEWIS, LLP, 1300 POST ROAD, SUITE 205, FAIRFIELD, CT, 06824, US

(73) Assignee: Rite-Solutions, Inc., Pawcatuck, CT (US)

(21) Appl. No.: 12/542,398

(22) Filed: Aug. 17, 2009

Related U.S. Application Data
(60) Provisional application No. 61/089,706, filed on Aug. 18, 2008.
(60) Provisional application No. 61/096,072, filed on Sep. 11, 2008.

(51) Int. Cl. G06F 9/44

(52) U.S. Cl. 719/318

(57) ABSTRACT

Methods and apparatus are provided for notifying individuals of the arrival and/or departure of public transportation vehicles. According to one aspect of the invention, one or more persons are notified regarding the location of a transportation vehicle. A subscription request is received from the one or more persons to receive a notification about the location of the transportation vehicle. The transportation vehicle is monitored to determine if one or more predefined notification events occur and a notification is sent if the predefined notification events occur. The predefined notification events comprise a predefined distance or time of the transportation vehicle from a predefined location. The subscription service is optionally fee-based. The system can optionally also provide entertainment to one or more riders on the transportation vehicle; determine an attendance of one or more riders on the transportation vehicle and/or identify one or more riders on the transportation vehicle using an identification token.

### CROSS-REFERENCE TO RELATED APPLICATIONS

This application claims priority to U.S. Provisional Application Ser. No. 61/089,706, filed Aug. 18, 2008, and U.S. Provisional Application Ser. No. 61/096,072, filed Sep. 11, 2008, each incorporated by reference herein.

### BACKGROUND OF THE INVENTION

There are a number of commercially available notification systems that facilitate communications with one or more recipients. For example, there are publish-subscribe systems that automatically distribute information to appropriate recipients when the information satisfies conditions included in the subscription, such as topical or key word conditions. In addition, further notification systems automatically send reminders to recipients regarding scheduled appointments or tasks requiring completion. A number of emergency notification systems provide public service messages or notifications to the public in the event of an emergency. For example, U.S. Pat. Nos. 6,463,462, 5,559,867 and 5,912,947 describe public notification systems that automatically contact users in an emergency.

Such notification systems typically allow recipients to designate their preferences regarding how they should be contacted, such as preferred communication devices at various times of day. For example, a user can designate a business telephone as their preferred communication device during normal business hours and a personal cellular telephone at other times.

While existing notification systems successfully notify users of an emergency or information that affects a large group of people, they typically do not provide notifications to individuals or smaller groups of people regarding more personal events, such as the arrival of a public transportation vehicle at a particular location, such as a designated stop. For example, a commuter may desire to know when a commuter train or bus is approaching a particular stop or a parent may wish to know when a school bus is approaching a particular stop. A need therefore exists for methods and apparatus for notifying interested users of the location of a transportation vehicle.

### SUMMARY OF THE INVENTION

Generally, methods and apparatus are provided for notifying individuals of the arrival and/or departure of public transportation vehicles, such as buses, trains or terries. According to one aspect of the invention, one or more persons are notified regarding the location of a transportation vehicle. A subscription request is received from the one or more persons to receive a notification about the location of the transportation vehicle. The system then monitors the transportation vehicle to determine if one or more predefined notification events occur and sends a notification if the predefined notification events occur.

The predefined notification events comprise a predefined distance or time of the transportation vehicle from a predefined location, such as a desired stop of the bus, train or ferry. The predefined distance or time is optionally based on positional tracking updates from the transportation vehicle.

The subscription service is optionally fee-based. The fee is optionally subsidized if one or more income requirements are satisfied. The notification can be sent using at least one media specified by the recipient. The notification can also be sent based on a predefined contact list.

The system can optionally also provide entertainment to one or more riders on the transportation vehicle. In a further variation, the system can optionally also determine an attendance of one or more riders on the transportation vehicle and/or identify one or more riders on the transportation vehicle using an identification token.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary transportation notification system incorporating features of the present invention;

FIG. 2 is a sample table of an exemplary subscriber database;

FIG. 3 is a sample table of an exemplary observed user database;

FIG. 4 is a sample table of an exemplary vehicle database;

FIG. 5 is a flow chart of an exemplary implementation of a registration process incorporating features of the present invention; and

FIG. 6 is a flow chart of an exemplary implementation of a notification process incorporating features of the present invention.

### DETAILED DESCRIPTION

The present invention provides a notification system 100 for public transportation vehicles. Among other benefits, the disclosed transportation notification system 100 provides information, cost and time saving benefits for users and providers of public transportation and school transportation, including commuters, parents and students. In addition, the present invention provides benefits to school systems, transportation providers, and state public safety officials.

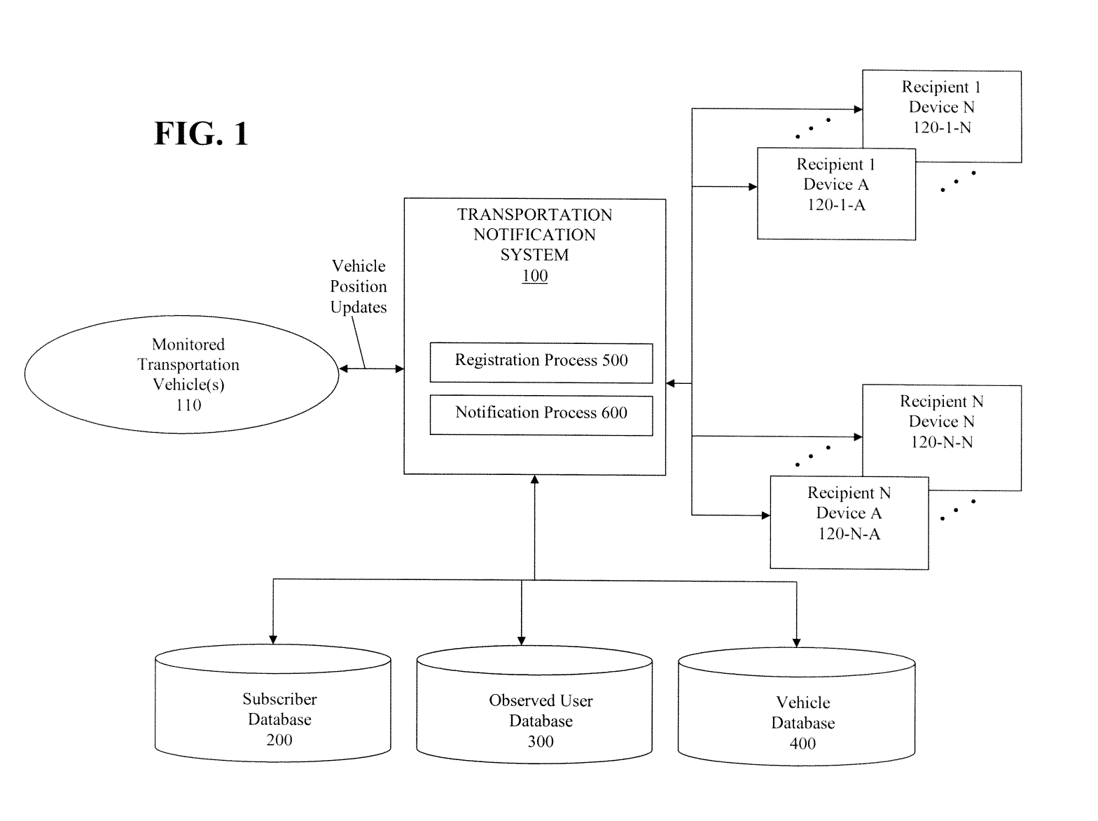

FIG. 1 illustrates an exemplary transportation notification system 100 incorporating features of the present invention. The disclosed transportation notification system 100 notification and response system 100 communicates with one or more recipients 120-1 through 120-N, hereinafter, collectively referred to as recipients 120, each on one or more devices A through N, such as devices for electronic mail, telephone, web page or facsimile. Generally, the transportation notification system 100 sends communications to one or more recipients 120 using the device specified by the recipient 120.

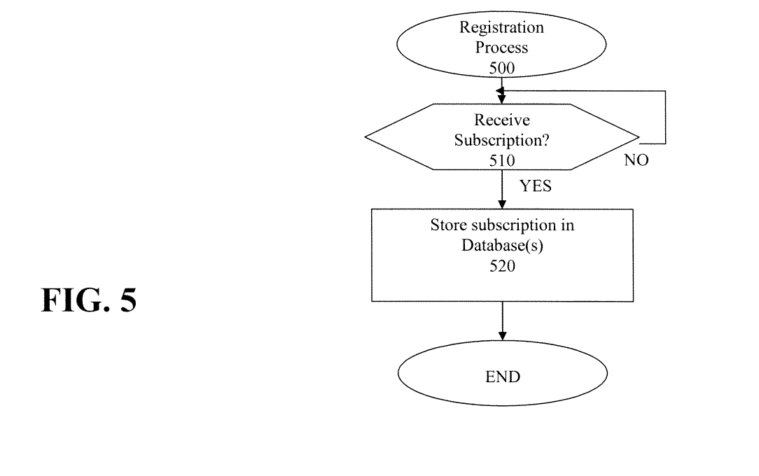

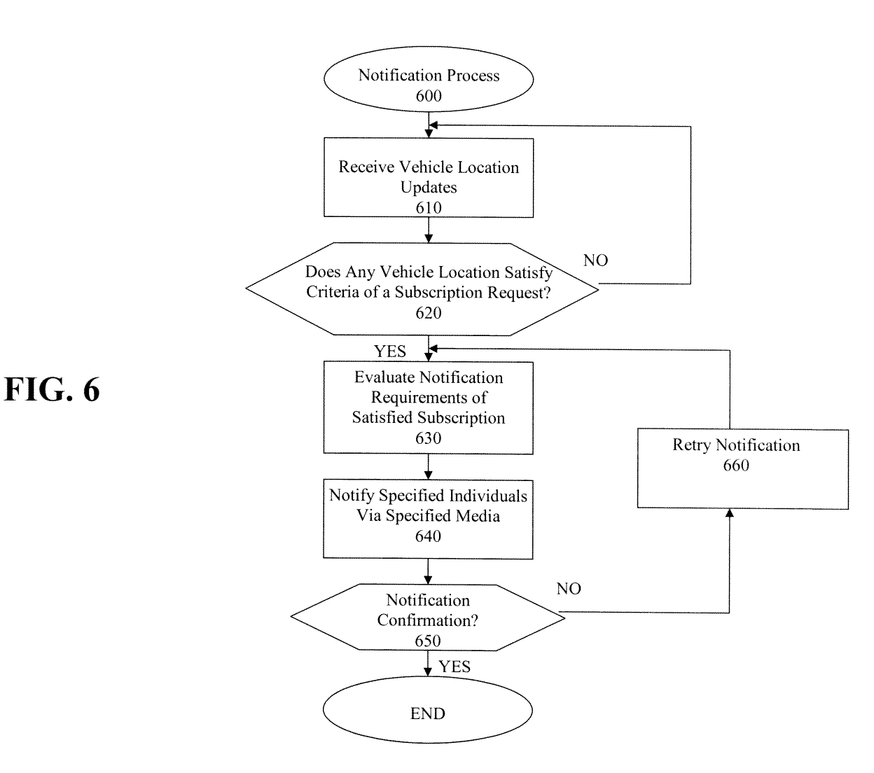

As shown in FIG. 1, the transportation notification system 100 comprises a registration process 500 and a notification process 600, discussed further below in conjunction with FIGS. 5 and 6. The registration process 500 allows users to register to receive notifications about the location of a transportation vehicle 110. The registration process 500 optionally provides an on-line browser interface that can be secure, username and password protected, and encrypted. In addition, the registration process 500 optionally allows parents to populate the appropriate databases through DTMF (dual tone multi frequency for touch tone phones) or voice response.

The notification process 600 monitors the location of one or more vehicles 110 and determines if one or more predefined notification events occur, such as a monitored vehicle 110 being a predefined distance or time from a predefined location, such as a train or bus stop. The registration information for each subscriber is recorded in a subscriber database 200. The registration information for each observed user, such as students, is recorded in an observed user database 300. The registration information for each monitored vehicle 110 is recorded in a vehicle database 400.

If a predefined notification event occurs, the notification process 600 generates a notification to the appropriate recipient 110. For example, the disclosed transportation notification system 100 allows parents of students to subscribe to receive specific notifications about the location and status of their child's buses. Parents are given accounts tied to their enrolled students as part of the student enrollment package at the beginning of the school year.

According to one aspect of the present invention, the transportation notification system 100 provides a funding/pricing model that allows public transportation providers, such as school systems, to implement the transportation notification system 100 at little or no cost. This is particularly important to budget restricted school systems which typically do not have available funds to implement these types of systems. In one exemplary implementation, the funding model utilizes a subscription fee to provide parents the notification functionality described herein. The subscription fee would typically be, for example, a small monthly fee based on either per household or per student charges. Provisions can be provided for billing through recurring credit card charges, direct account withdrawals, bulk payments, subsidized subscriptions for low income and other methods. The funding model allows fees to be set quite low, if desired, such as a few dollars per month. In this manner, the collected fees can optionally offset some or all of the costs for the transportation notification system 100, including capital and installation costs and operational costs, such as communications and maintenance costs. In fact, with a large participation rate, the costs to a school system could be zero and even result in a surplus to invest in technology advances and upgrades.

As discussed hereinafter, the disclosed transportation notification system 100 provides automated notifications to specified subscribers using specified media when one or more predefined conditions are satisfied. The disclosed notification technology saves subscribers time normally spent waiting for transportation vehicles, such as school buses. In the case of school buses, parents particularly desire to ensure that they are not late when the bus arrives to pick up students in the morning and to drop off in the afternoon. Thus, parents typically unnecessarily arrive at bus stops at the earliest possible time that the bus could arrive to ensure that they are not late.

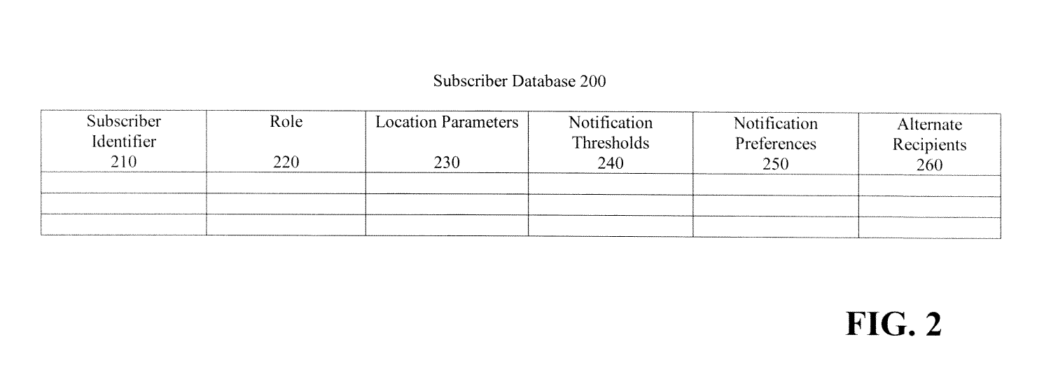

FIG. 2 is a sample table of an exemplary subscriber database 200. Generally, the subscriber database 200 records information for each subscriber of the transportation notification system 100. As shown in FIG. 2, each record corresponds to a different subscriber identified by a subscriber identifier in field 210. For each subscriber, the subscriber database 200 indicates the role of the subscriber in field 220, and the corresponding location parameters, notification thresholds, notification preferences and alternate recipients associated with the subscription in fields 230 through 260. The role indicated in field 220 may comprise, for example, a parent, employee (secretary) or self role. The location parameters in field 230 may indicate a predefined location for the notification, such as a train or bus stop. The notification threshold in field 240 may indicate the predefined distance or time from the predefined location that should trigger the notification (such as one quarter mile from the location).

The alternate recipients indicated in field 260 allow a contact escalation with multiple contact points, for example, in the event that the primary subscriber cannot be reached. For example, the multiple contact points can specify multiple parents, grandparents and guardians, in a particular order. The contact information can optionally specify particular devices for each recipient as a function of time.

The subscriber database 200 can optionally also be configured to record payment information, such as credit, paper bill or direct withdrawal. For low income families, functionality can optionally be provided to allow the parents to confirm that they are eligible for reduced or no cost enrollment.

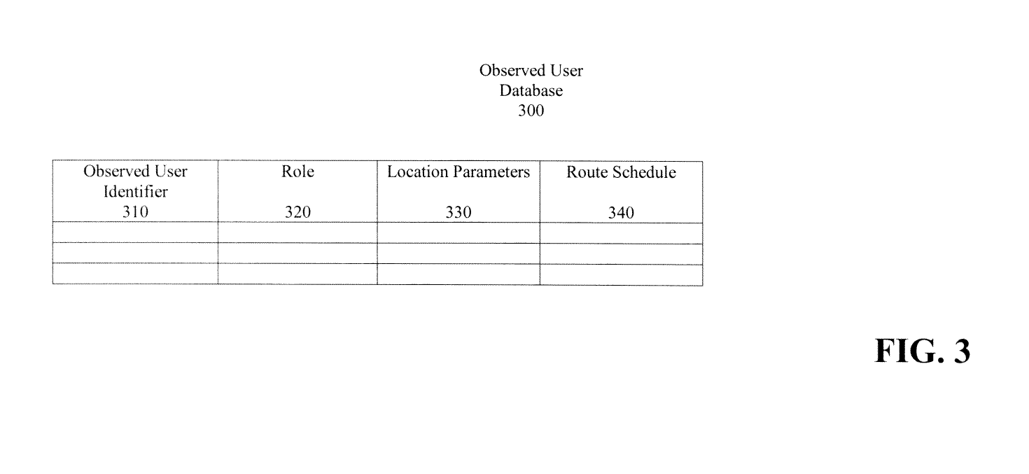

FIG. 3 is a sample table of an exemplary observed user database 300. Generally, the observed user database 300 records information for each observed user, such as a student, boss (employer) or the subscriber him or herself. As shown in FIG. 3, each record corresponds to a different observed user identified by an observed user identifier in field 310. For each observed user, the observed user database 300 indicates the user's role in field 320 (such as student, employer or self), as well as corresponding location parameters in field 330 and the route schedule in field 340. The location parameters in field 330 can identify the bus or train stop locations that are monitored for the user, and the route schedule in field 340 can indicate the scheduled time for each stop.

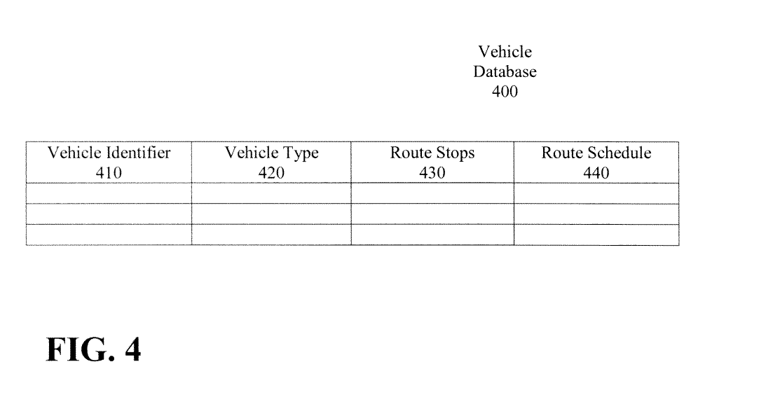

FIG. 4 is a sample table of an exemplary vehicle database 400. Generally, the vehicle database 400 records information for each observed vehicle. As shown in FIG. 4, each record corresponds to a different vehicle identified by a vehicle identifier in field 410. For each observed vehicle, the vehicle database 400 indicates the vehicle type in field 420 (such as bus or train), the route stops in field 430 and the route schedule in field 440.

The information in the vehicle database 400 may be populated, for example, by data input or by running an automated system that gathers information about stops, such as a global positioning system (GPS). This data is typically transmitted over one of many available wireless media (private band radio, cellular data network, etc). This data becomes part of the historical database for the route to improve the quality of the tracking/prediction/notification algorithms that are used to notify a recipient of a vehicle at its specified notification points. The algorithm can initially be based on an average bus speed based on traffic regulations. This algorithm can be superseded by the actual historical time it has taken the vehicle to transit various portions of its route.

FIG. 5 is a flow chart of an exemplary implementation of a registration process 500 incorporating features of the present invention. As shown in FIG. 5, the registration process 500 initially performs a test during step 510 to determine if a new or updated subscription registration is received. If it is determined during step 510 that a new or updated subscription registration is received, then the details of the new or updated subscription registration are recorded in the appropriate subscriber database 200, observed user database 300 and/or vehicle database 400 during step 520. If, however, it is determined during step 510 that a new or updated subscription registration is not received, then program control returns to step 510 until a new or updated subscription registration is detected.

FIG. 6 is a flow chart of an exemplary implementation of a notification process 600 incorporating features of the present invention. As shown in FIG. 6, the notification process 600 initially receives vehicle location updates during step 610. For example, the notification process 600 can monitor vehicle updates that provide specific notifications about the location and status of trains and/or buses.

A test is performed during step 620 to determine if any vehicle location satisfies criteria of a subscription request (such as a predefined time or distance of a certain vehicle from a specified location). If it is determined during step 620 that no vehicle locations satisfy criteria of a subscription request, then program control returns to step 610 until a matching vehicle location is detected to trigger a notification.

If, however, it is determined during step 620 that a vehicle location does satisfy criteria of a subscription request, then the notification requirements of the satisfied subscription are evaluated during step 630. The specified individuals are notified via the specified media during step 640.

A test is optionally performed during step 650 to determine if a notification confirmation is received. If it is determined during step 650 that a notification confirmation is not received, then program control proceeds to step 660 to retry the notification. If, however, it is determined during step 650 that the notification confirmation is received, then program control terminates.

The transportation notification system 100 optionally supports confirmed acknowledgement of the notification (e.g., phone is answered, email is answered, or a reply is received for an SMS message). The transportation notification system 100 also optionally enables the use of a contact escalation tree which is used to proactively move through a series of contact methods (for instance, home phone, father's work phone, mother's work phone, father's cell phone, mother's cell phone, grandparents home phone, etc.) until contact is acknowledged. This functionality simplifies the parent's decision process in establishing the contact method since they can establish a single contact tree that can be used for all notifications. If one of the contact methods on the tree is out of service (father's cell phone is turned off), the system will rapidly continue through the tree and use the next notification method.

It is noted that the above-described techniques can also be applied in a public transportation environment. In this manner, aspects of the invention allow commuters and other uses of public transportation to catch, for example, a bus, train or ferry, without having to get to the designated stop too early. Based on a subscriber model, a customer can subscribe to the service and be notified, for example, by text, email or phone call, when a desired bus, train or ferry is approaching a desired stop. The notification can be sent to the subscriber, for example, based on a designated time or distance before the bus, train or ferry reaches the desired stop. A subscriber can optionally selectively request notification of one or more particular buses, trains or ferries on a given route approaching a desired stop in a given window of time, such as, for example, the “5:07 pm N17 Bus approaching the stop at the corner of Madison Avenue and 42d Street;” or “all N17 Buses approaching the stop at the corner of Madison Avenue and 42d Street between 4:30 pm and 6:30 pm.”

Additional Optional Capabilities

A. Edu-tainment

With the existence of a powerful computer on the public transportation vehicle and bandwidth between the vehicle and a central computer, the system is able to provide educational entertainment to riders (e.g., a Child News Network). It can also provide information about the upcoming day (lunch menus, sporting events, etc). All of this is provided via the on-board computer, the network and in vehicle displays. Additionally, the on-board computer can be the hub for wireless devices in the riders' possession for other more personalized activities (e.g., handheld Trivial Pursuit on the bus, possibly in competition with other riders on the same vehicle).

B. Attendance and Truancy Applications

By being able to operate early on attendance and truancy issues, the system can provide early notification to school officials and truancy officials when students are not on the bus. Therefore, allowing the appropriate officials to react early enough to possibly get the student to class rather than just find out about it at half way through the day.

C. Identification Through RFID

The system also optionally allows the use of specific tokens for identifying the students on the buses or the riders on public transit. These tokens (RFID's) can provide additional functionality such as:

1. attendance functionality;

2. fare cards; and

3. for use in surveying riders through the trip (tracking transfers, etc) and also being able to gather ridership data about the riders use over time (being able to determine riders that ride every day, every other day, those that ride only one way, etc.) These surveys can be anonymous or identified depending on the objectives or restrictions in data collection.

4. These tokens can also be used in ancillary functions (particularly at schools) as library card, access to specific areas of the school campus, lunch payment cards, automated attendance trackers in the classroom (with the addition of RFID readers in the classroom).

Process, System and Article of Manufacture Details

While a number of flow charts herein describe an exemplary sequence of steps, it is also an embodiment of the present invention that the sequence may be varied. Various permutations of the algorithm are contemplated as alternate embodiments of the invention. While exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware. Such software may be employed in, for example, a digital signal processor, application specific integrated circuit, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for notifying one or more persons regarding the location of a transportation vehicle, comprising:
receiving a subscription request from said one or more persons to receive a notification about the location of said transportation vehicle;
determining if one or more predefined notification events occur, wherein said one or more predefined notification events comprise a predefined distance or time of said transportation vehicle from a predefined location; and
generating a notification to said one or more persons if said one or more predefined notification events occur

2. The method of claim 1, wherein said transportation vehicle comprises one or more of a bus, train or ferry.

3. The method of claim 2, wherein said predefined location is a desired stop of said bus, train or ferry.

4. The method of claim 1, further comprising the step of receiving a fee with said subscription.

5. The method of claim 4, wherein said fee is subsidized if one or more income requirements are satisfied.

6. The method of claim 1, wherein said notification is sent to one or more of at least one specified individual using at least one specified media.

7. The method of claim 1, wherein said notification is sent based on a predefined contact list.

8. The method of claim 1, wherein said predefined distance or time is based on positional tracking updates from said transportation vehicle.

9. The method of claim 1, further comprising the step of providing entertainment to one or more riders on said transportation vehicle.

10. The method of claim 1, further comprising the step of determining an attendance of one or more riders on said transportation vehicle.

11. The method of claim 1, further comprising the step of identifying one or more riders on said transportation vehicle using an identification token.

12. A system for notifying one or more persons regarding the location of a transportation vehicle, comprising:
a memory; and
at least one processor, coupled to the memory, operative to:
receive a subscription request from said one or more persons to receive a notification about the location of said transportation vehicle;
determine if one or more predefined notification events occur, wherein said one or more predefined notification events comprise a predefined distance or time of said transportation vehicle from a predefined location; and
generate a notification to said one or more persons if said one or more predefined notification events occur

13. The system of claim 12, wherein said transportation vehicle comprises one or more of a bus, train or ferry.

14. The system of claim 13, wherein said predefined location is a desired stop of said bus, train or ferry.

15. The system of claim 12, wherein said processor is further configured to receive a fee with said subscription.

16. The system of claim 15, wherein said fee is subsidized if one or more income requirements are satisfied.

17. The system of claim 12, wherein said notification is sent to one or more of at least one specified individual using at least one specified media.

18. The system of claim 12, wherein said notification is sent based on a predefined contact list.

19. The system of claim 12, wherein said predefined distance or time is based on positional tracking updates from said transportation vehicle.

20. An article of manufacture for notifying one or more persons regarding the location of a transportation vehicle, comprising a machine readable storage medium containing one or more programs which when executed implement the steps of:
receiving a subscription request from said one or more persons to receive a notification about the location of said transportation vehicle;
determining if one or more predefined notification events occur, wherein said one or more predefined notification events comprise a predefined distance or time of said transportation vehicle from a predefined location; and
generating a notification to said one or more persons if said one or more predefined notification events occur
